(19) United States
(12) Patent Application Publication
(10) Pub. No.: US 2017/0193780 A1
(43) Pub. Date: Jul. 6, 2017

(54) MERCHANDISING DISPLAY SECURITY SYSTEM

(71) Applicant: InVue Security Products Inc., Charlotte, NC (US)

(72) Inventors: Andrew W. Moock, Brecksville, OH (US); Phillip Stein, Waxhaw, NC (US); Jeffrey A. Grant, Charlotte, NC (US)

(21) Appl. No.: 15/454,457

(22) Filed: Mar. 9, 2017

Related U.S. Application Data
(63) Continuation of application No. 13/856,664, filed on Apr. 4, 2013.
(60) Provisional application No. 61/620,621, filed on Apr. 5, 2012.

(51) Int. Cl. G08B 13/24; H04M 1/725; G06Q 30/02

(52) U.S. Cl. CPC G08B 13/2462; G06Q 30/0201; H04M 1/72572; H04M 1/72569

(57) ABSTRACT

A merchandising security system and method are provided. For example, the security system includes a merchandising display configured to display an electronic item of merchandise at a display position in a retail store, a digital interface box (DIB), and a media player operably coupled to the DIB. The DIB and the media player are configured to communicate with the electronic item of merchandise. The merchandising display is configured to communicate with the electronic item of merchandise for generating a security alarm when the electronic item of merchandise is moved to an unauthorized location

### FIELD OF THE INVENTION

Embodiments of the present invention relate generally to merchandising display security systems used in retail stores.

### BACKGROUND OF THE INVENTION

InVue Security Systems Inc. and other merchandise display security device manufacturers have developed interactive digital signage systems that provide information to consumers regarding the technical features and capabilities of the articles of merchandise on display in a retail store. In some instances, the interactive digital signage system further provides sales information to the retailer, including without limitation, the number of times a consumer interacts with a particular article of merchandise from the display. More specifically, the interactive digital signage system tracks the number of times an article of merchandise disposed on a particular display stand is picked-up, and in some instances, the duration of time that the customer interacted with the merchandise. This type of sales information is useful, however, only when the store personnel have manually input data into the system that properly identifies the article of merchandise being displayed on the display stand. Furthermore, such a system requires store personnel to continually monitor the articles of merchandise on display and to update the identity of the merchandise when the article of merchandise on the display stand is changed.

Modern electronic articles of merchandise (e.g. consumer electronics) are becoming more sophisticated and often include technology that identifies and tracks movements of the article of merchandise. One example is a “smart” phone that is equipped with software for communicating with other electronic devices via a global computer network, such as the Internet. Many smart phones are also provided with a motion sensor, for example an accelerometer, and computational software for detecting movement of the smart phone. In some instances, the smart phone further includes a gyroscope and inertial guidance or navigation software for determining the location of the smart phone relative to a reference location. As yet, however, the motion detecting and tracking capabilities of the smart phone have not been leveraged for reporting sales information to a retailer regarding a smart phone on display in a retail store. Presently, mobile phones utilizing the Android and Blackberry operating systems have the capability to provide an “always-on” process that monitors and reports customer interactions with an article of merchandise on display in a retail store.

### BRIEF SUMMARY OF THE INVENTION

Embodiments of the present invention are directed to merchandising systems and methods for tracking user interaction with electronic items of merchandise on display in a retail store. For example, the method includes obtaining identifying information from an electronic item of merchandise on display and detecting user interaction with the electronic item of merchandise. The method further includes tracking information relating to the detected user interaction with the electronic item of merchandise. Such a method may be performed directly by the electronic item of merchandise or by a merchandise display system in communication with the electronic item of merchandise.

According to various aspects, the method further comprises communicating the identifying information and the tracked information to a remote server or computer. For example, the identifying information and the tracked information may be communicated over a global computer network. Various types of information may be tracked and recorded, such as a date and time that a user interacts with the electronic item of merchandise or a duration that a user interacts with the electronic item of merchandise. In particular, the method may include recording a date and time that the electronic item of merchandise is removed from a display position and a date and time that the electronic item of merchandise is returned to the display position.

Other aspects of the method include displaying information relating to the electronic item of merchandise. Moreover, the detecting step may include detecting when a user has picked up the electronic item of merchandise from a display stand. The detecting step may further include detecting when a user interacts with the electronic item of merchandise while the electronic item of merchandise is supported on a display stand. In one aspect, the detecting step includes monitoring user interaction with a motion sensor associated with the electronic item of merchandise.

In another embodiment, a merchandising display system for tracking user interaction with electronic items of merchandise on display in a retail store is provided. The system includes a merchandising display configured to display an electronic item of merchandise at a display position in a retail store and to detect user interaction with the electronic item of merchandise. The system further includes a digital interface box (DIB) and a media player operably coupled to the DIB. The DIB and the media player are configured to be in communication with the electronic item of merchandise, wherein the DIB or media player is configured to obtain identifying information from the electronic item of merchandise and to track information relating to a user's interaction with the electronic item of merchandise.

In some aspects, the merchandising display comprises a display stand configured to removably support the electronic item of merchandise. In this case, the merchandising display may be configured to detect when the electronic item of merchandise has been removed from the display stand, and the DIB or media player may be configured to record when the electronic item of merchandise has been removed from the display stand. The system may further include a digital display monitor configured to display information relating to the electronic item of merchandise to a user. The DIB or media player may be further configured to communicate the identifying information and the tracked information to a remote server or computer, such as over a global computer network. In addition, the DIB or media player may be configured to record a date and time that the electronic item of merchandise is removed from the display position and a date and time that the electronic item of merchandise is returned to the display position.

### BRIEF DESCRIPTION OF THE DRAWINGS

FIG. 1 is an environmental perspective view depicting one embodiment of a merchandising system according to the invention.

FIG. 2 is a schematic diagram illustrating data communications between a merchandising system and a remote server or computer, according to one embodiment of the present invention.

FIGS. 3 and 4 are environmental perspective views depicting various embodiments of a merchandising system and merchandise displays according to the invention.

FIG. 5 is a flowchart illustrating one embodiment of a method according to the invention.

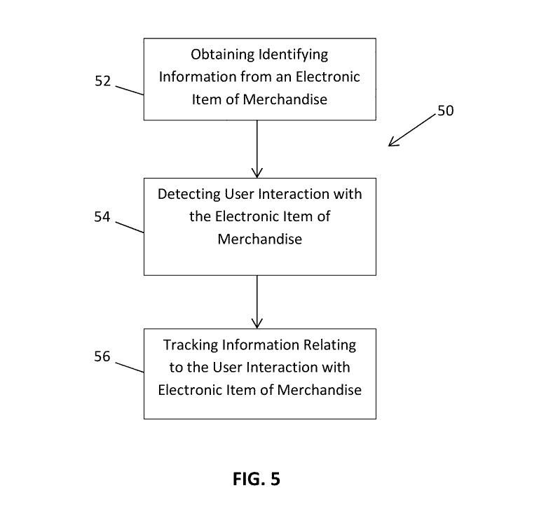

### DETAILED DESCRIPTION OF THE INVENTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and multiple prime notations are used to indicate similar elements in alternative embodiments.

The accompanying drawing figures, wherein like reference numerals denote like elements throughout the various views, show one or more embodiments of a merchandising system and method for tracking user interaction with an article of merchandise in a merchandise display. In one embodiment and as explained in further detail below, the system and method utilize the merchandise display and/or user tracking capabilities of an interactive digital signage merchandise display system to identify the article of merchandise for display and/or to track the number of user interactions (e.g., pickups) with the merchandise. In another embodiment and as also explained in further detail below, the merchandise itself is provided with a software application that identifies the article of merchandise and utilizes features of the merchandise itself to track the number of user interactions (e.g., pickups) with the merchandise.

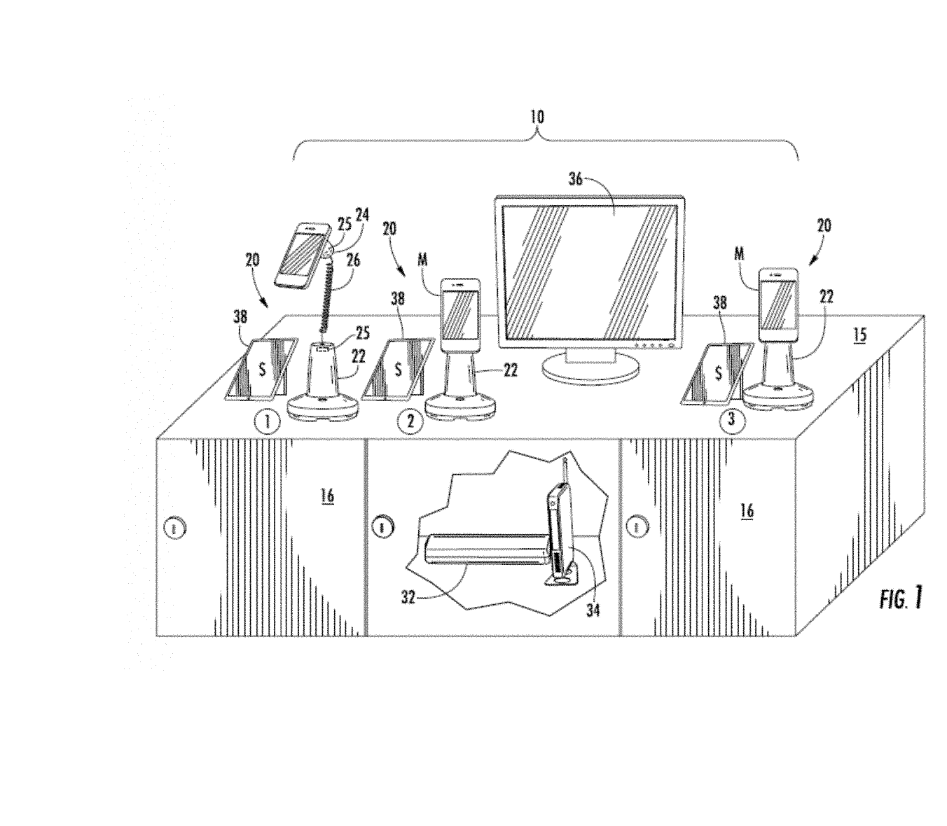

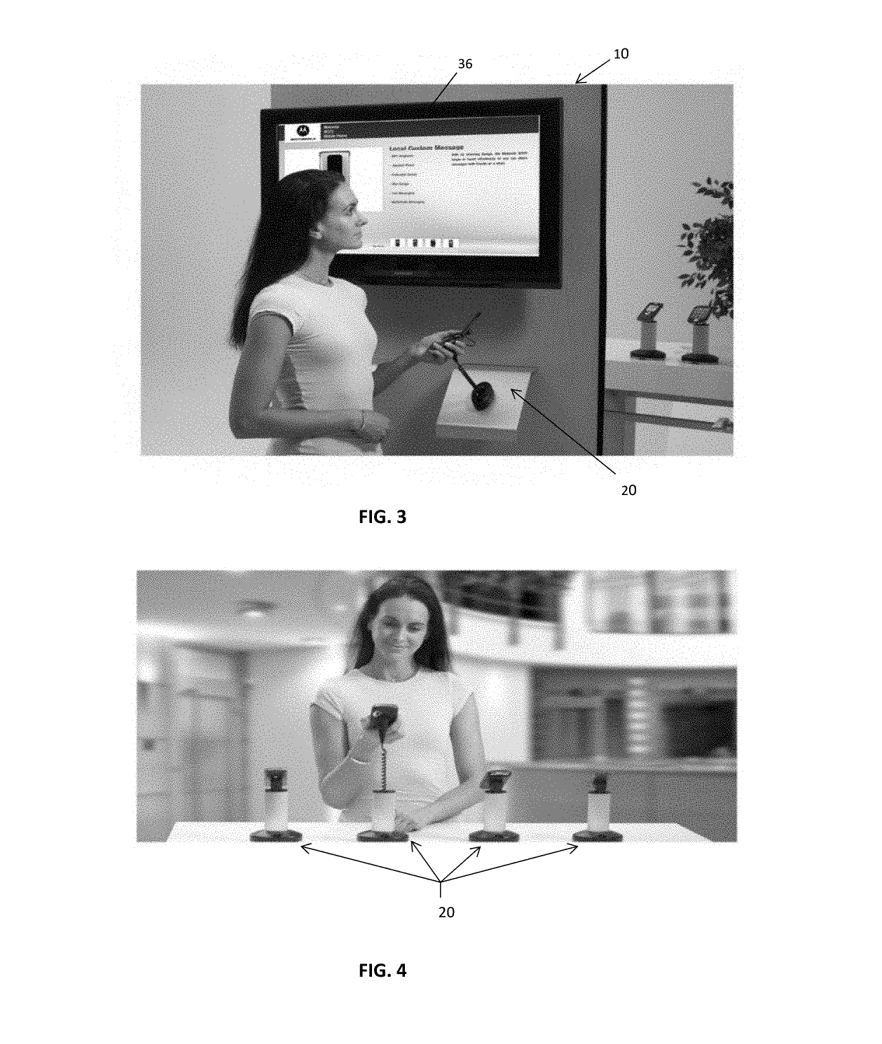

FIGS. 1 and 3 show embodiments of a merchandising display system, indicated generally at 10. By way of example and not limitation, merchandising display system 10 comprises one or more display positions and in some embodiments, a plurality of display positions numbered 1, 2 and 3 on a display support surface 15, such as a display counter, table, shelf, cabinet or the like, for displaying items of merchandise M at a point of sale in a retail store (see FIGS. 1 and 4). As shown in FIG. 1, a merchandising display 20 is provided at each display position 1, 2 and 3. The merchandising display 20 may include any display configured to display an item of merchandise M. In one embodiment, the merchandising display 20 depicted is a Series 1000 POD merchandise display stand of a stand-alone alarm system commercially available from InVue Security Products Inc. of Charlotte, N.C. However, various other merchandising displays 20 capable of being configured for use with an electronic retail merchandising system, also commonly referred to as a digital signage system, are suitable for use with the invention. As shown, each merchandising display 20 comprises a display stand 22 and a sensor 24 that is removably supported on the display stand. Sensor 24 may mechanically and electrically connected to the display stand 22 by a multi-conductor electromechanical cable 26 for conducting electrical signals, for example sense loop and electrical power signals, between the sensor and the display stand. It is understood that wireless communication between the sensor 24 and display stand 22 may also be possible in other embodiments. In either case, an item of merchandise M is physically attached to the sensor 24. In many instances, the item of merchandise M is a battery-operated, handheld electronic device, such as a mobile (e.g. cellular) telephone, digital media players, game console, personal data assistant (PDA), digital camera, or the like, and an electrical cable (not shown), commonly referred to as a power adapter cord, is electrically connected between the sensor and the merchandise in a known manner.

If desired, the sensor 24 may comprise a sensor element, such as a plunger and plunger switch, for detecting whether item of merchandise M is in contact with or attached to the sensor. Consequently, the display stand 22 may comprise monitoring electronics for monitoring the state of the sensor element and for activating an audible and/or visible alarm in the event that the item of merchandise M is removed from the sensor 24 in an unauthorized manner, such as by a potential thief attempting to steal the item of merchandise. Regardless, the merchandising display 20 may further comprise a triggering mechanism or means 25 for indicating that the sensor 24, and consequently the item of merchandise M attached to the sensor, has been lifted or picked up from the display stand 22. The triggering mechanism or means 25 may be any suitable mechanical, optical, or electrical mechanism for detecting that the item of merchandise M has been picked up. According to one embodiment of the invention herein, the triggering mechanism or means 25 may be cooperating magnets disposed on the display stand 22 and the sensor 24, respectively. Corresponding detection electronics disposed in display stand 22 detect a disruption in a magnetic field generated by the sensor 24 being properly positioned and supported on the display stand that indicates the sensor, and consequently the item of merchandise M, has been removed (i.e. lifted) from the display stand. However, it is understood that triggering mechanism or means 25 may comprise other electronic, optical, or mechanical mechanisms for detecting when the item of merchandise M has been removed from the display stand 22 or other support surface. With respect to the merchandising system 10, each lifting of the sensor 24 and the item of merchandise M is referred to herein as a “pick-up”.

The merchandising display 20 at each of the display positions 1, 2 and 3 is operably coupled to an electronic merchandising and media content control module, indicated generally at 30. In the exemplary embodiments shown and described herein, control module 30 comprises a digital interface box (DIB) 32, a media player 34 and a digital monitor 36 of the type provided with the ybuy® digital signage system commercially available from InVue Security Products Inc. of Charlotte, N.C. DIB 32 and media player 34 may be located beneath the display support surface 15 at a convenient location within a lockable cabinet 16 to which access is limited to authorized store personnel. The digital monitor 36 is operably coupled to DIB 32 and media player 34, and is positioned on the display support surface 15 at a convenient location for viewing by a user or customer interacting with the item of merchandise M attached to the sensor 24 of the merchandising display 20. Merchandising display 20, DIB 32, media player 34 and digital monitor 36 are in data communication with one another as necessary via electrical cables comprising electrical conductors, or alternatively, via wireless data communications equipment. If desired, an electronic price tag 38 may be likewise operably coupled to the DIB 32 and the media player 34 for displaying information, including for example products specifications, price, sales and/or leasing information, relating to the item of merchandise M being displayed on the corresponding merchandising display 20. As used herein, the term “operably coupled” is intended to include hard-wiring, such as using electrical cables comprising one or more electrical conductors or the like, as well as any wireless communication technology now known or hereafter devised.

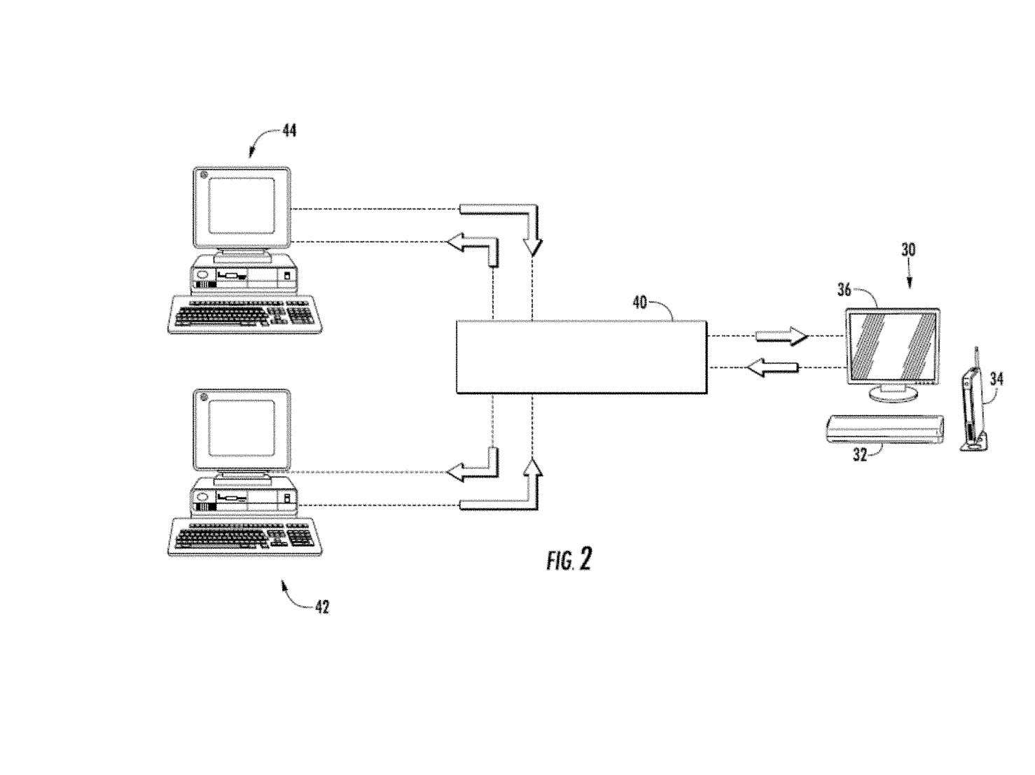

In one embodiment, FIG. 2 illustrates data communications between a network, e.g., a global computer network (e.g., Internet portal), indicated generally at 40, and the electronic merchandising and media content control module 30 (DIB 32, media player 34, and digital monitor 36) of the merchandising system 10. As will be readily understood and appreciated by those skilled in the art, the global computer network (e.g., Internet portal) 40 may be in the form of an Internet portal having a Uniform Resource Locator (URL) address for access by a communications device, such as a conventional computer or processing element, having hardware and software operable for exchanging data transmissions with another communications device via the Internet portal in a known manner. However, the global computer network 40 may be any communications network configured for transmitting and receiving data communications between the control module 30 of the merchandising system 10 and a remote digital communications device. FIG. 2 further illustrates data communications between the global computer network (e.g. Internet portal) 40 and a remote server or computer, such as a remote server or computer 42 located at a retailer, and more particularly, at the corporate office of the retailer. FIG. 2 further illustrates that the Internet portal 40 and a remote server or computer 44 located at a retail store of the retailer may be in communication with one another.

In one embodiment, the retailer develops a merchandising system 10 comprising a number and arrangement of merchandising displays 20 for displaying, securing and/or powering items of merchandise M and a corresponding electronic merchandising and media content control module 30, commonly referred to as a “planogram,” to be installed in each of a plurality of similar retail stores located at different physical locations. In addition, the retailer compiles and populates the control module 30 with media content relating to the items of merchandise M and maps the media content to the merchandising displays 20 associated with the items of merchandise M corresponding to the media content. The media content for a particular item of merchandise M is able to be displayed on the digital monitor 36 upon a user interacting or picking up the item of merchandise. The terms “multimedia content” or “media content” are used herein to mean audio, visual and/or audiovisual information relating to the items of merchandise M being displayed on the merchandising displays 20 of the merchandising system 10.

Once the electronic retail merchandising program is installed and operating at a retail store, the triggering mechanism or means 25 of the merchandising display 20 detects a “pick-up” of the sensor 24 and the item of merchandise M being displayed on the merchandising display in the manner previously described. The control module 30 (e.g. DIB 32 or media player 34), records data including, for example, the date/time of each pick-up, the total number of pick-ups, the duration of each pick-up, the date/time that the item of merchandise M is returned to the display stand 22, and the total duration of the pick-ups. Accordingly, the retailer may analyze the data to determine, for example, the number of pick-ups over a preselected period of time (e.g. pick-ups/hour) and the average duration of each pick-up (e.g. seconds/pick-up).

When an item of merchandise M, such as a smart phone, is electrically connected to the media player 34 and/or DIB 32 via a power cable, the item of merchandise M is configured to communicate identifying information of the item of merchandise M to the media player and/or DIB. For example, the identifying information may be any type of information used to identify the item of merchandise such as, for example, the item's display position, model number, serial number, brand, and/or other information suitable to identify the item of merchandise. Various means may be employed to obtain the identifying information from the item of merchandise, such as with the media player 34 and/or DIB or with a host server or computer 42 or 44, which may be communicated by the item of merchandise M. In some cases, the identifying information may be obtained directly by the item of merchandise M, as explained in further detail below. The identifying information may be obtained automatically from the item of merchandise M, such as upon installation of the item at the merchandise display 20 or upon pick up of the item from the display stand 22, or the media player 34 and/or DIB 32 may request the identifying information from the item of merchandise. The identifying information may be used by the merchandise system 10 to display the proper media presentation for the item of merchandise M on the digital display monitor 36, and/or to track and report user interactions with the item of merchandise. In another aspect, the media player 34 and/or DIB 32 may communicate data, including the identifying information of the item of merchandise M, to a host server or computer 42 or 44 at a remote location. For example, the media player 34 and/or DIB 32 may be in data communication with a reporting server located at a corporate office of the retailer via a global computer network, such as the Internet.

As discussed above, the merchandise display system 10 is configured to detect when the item of merchandise M is picked up from the display stand 22. Various means may be used to track such user interaction. For example, the media player 34 and/or DIB 32 may be configured to record the “pick-up” event, and optionally, the duration of time that the item of merchandise M is removed from the display stand 22. More specifically, the media player 34 and/or DIB 32 may record the date and time that the item of merchandise M is removed from the display stand 22 and the date and time that the item of merchandise M is returned to the display stand, and then calculate the duration of time that the customer interacted with the item of merchandise M.

In one embodiment, the merchandise display system 10 leverages the motion sensing capability of the item of merchandise M to track the duration of time that the customer interacts with the item of merchandise M. For example, the item of merchandise M may include a motion sensor, such as an accelerometer, and the media player 34 and/or DIB 32 may record the duration of time that the accelerometer is producing a signal indicating movement of the item of merchandise M. In this manner, the media player 34 and/or DIB 32 would detect and record a customer interaction even if the item of merchandise M is not removed from the display stand 22.

In another embodiment, the identifying information and motion sensing capability of an item of merchandise M is leveraged to provide a merchandise display security system 10 including a merchandise user tracking system and method. The item of merchandise M may be electrically connected to a host server or computer 42 or 44 that is configured to interrogate the identifying information and motion sensor data of the item of merchandise M. More particularly, the item of merchandise M may be provided with a software application (“app”) other otherwise programmed (e.g., via computer program code or instructions) for detecting user interaction and tracking such interaction. Thus, the app may be configured to interrogate the identifying information and motion sensor data of the item of merchandise M and to communicate the identifying information and motion sensor data to a host server or computer 42 or 44 at a remote location, as previously described. In the latter instance, the retailer loads the app into the item of merchandise M, activates the app, and provides the identifying information to the app. In one embodiment, the app automatically collects and communicates the identifying information of the item of merchandise M to the host server or computer 42 or 44. The app thereafter monitors the motion sensor of the item of merchandise M and detects when a user interacts with the item of merchandise M, as well as the duration of time that the customer interacts with the Item of merchandise M.

As previously described, the merchandise display security system 10 may include an optional display stand 22 for removably supporting the item of merchandise M in a desired display location and orientation. However, the display stand 22 may be omitted and the item of merchandise M may be displayed by itself on a display table, counter, shelf, or the like without a display stand or similar support. Regardless, the motion sensor of the item of merchandise M, for example, an accelerometer, is configured to sense when a customer is interacting with the item of merchandise M and communicate a signal to the security system 10. The signal activates the host server or computer 42 or 44 to record an interaction (e.g., pick-up) of the item of merchandise M and to record the duration of time of interaction with the item of merchandise M. In addition, the signal may activate a security alarm to sound in the event that the item of merchandise M is moved from the desired display location to an unauthorized location.

The host server or computer 42 or 44 may be configured to analyze the identifying information and motion sensor data to compile analytics regarding customer interactions with the item of merchandise M. The interaction analytics may be used, for example, to determine which ones of a plurality of items of merchandise M customers are interacting with more often, or for longer periods of time. In addition, the capabilities of the item of merchandise M may be further leveraged to determine which functions or features of the item of merchandise M customers are interacting with on a frequent basis, as well as the duration of time that customers interact with a specific function or feature of the item of merchandise M. Because identifying information for each item of merchandise is provided, the information tracked is more useful to the retailer, and the retailer is able to readily obtain tracking information since the identifying information does not need to be manually entered and may be automatically updated.

FIG. 3 illustrates an exemplary embodiment of a method, indicated generally at 50, according to the invention for tracking user interaction with electronic items of merchandise on display in a retail store. In a first step indicated at 52, identifying information for an electronic item of merchandise on display is obtained. As discussed above, identifying information from the item of merchandise may be obtained by the media player and/or DIB or by a host server or computer. Or, the identifying information may be obtained directly by the item of merchandise. In a second step indicated at 54, user interaction with the identified electronic item of merchandise is detected. For example, a pick-up of the item of merchandise may be detected, or user interaction with the item of merchandise may be detected even when the item of merchandise is on the display stand. In a third step indicated at 56, the method includes tracking information relating to the detected user interaction with the identified electronic item of merchandise. As discussed above, such information may include a date and time that a user interacts with the identified electronic item of merchandise, or a duration that a user interacts with the identified electronic item of merchandise. The information may be obtained, for example, by the media player and/or DIB or directly by the item of merchandise.

It is contemplated that one or more steps for tracking user interaction with electronic items of merchandise may be stored in various forms of computer-readable medium. The term “computer-readable medium” as used herein refers to any medium that participates in providing information to an item of merchandise or controller (e.g., DIB or media player), including instructions for execution. Such a medium may take many forms, including, but not limited to a computer-readable storage medium (e.g., non-volatile media or volatile media) and non-transitory media (as opposed to transitory, propagating signals). Non-transitory media, such as non-volatile media, include, for example, optical or magnetic disks. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read.

In another embodiment, a host server or computer 42 or 44 is provided to manage client licenses to a merchandise display security system 10 including a merchandise user tracking system. The server 42 or 44 may further manage activations of the system 10 by store personnel authorized by the retailer. Preferably, the server 42 or 44 is publicly accessible so that items of merchandise M (e.g., smart phones) on display in a retail store are able to access the server 42 or 44 over the retailer's Internet portal 40. To prevent unauthorized access and tampering, the activation server 42 or 44 and the application may be provided with a security key. An administration interface for the activation server 42 or 44 will administer licenses to retailers and collection of revenue for the number of merchandise displays that are activated by the retailer.

A reporting service may also be provided for reporting the analytics recorded and computed by the host server or computer 42 or 44. Two possible approaches are contemplated for the reporting service. In particular, the reporting server may be client hosted or Software as a Service (SaaS). Each approach may have certain benefits and detriments. With a client hosted reporting server, the benefits may include: 1) the client assumes all hardware and operating costs; 2) there is a potential alternative revenue stream for setup assistance and service contracts; and 3) the clients “own” their data and can, at any time, do whatever they wish with their data since it is contained on a server within their control. Alternatively, with a SaaS reporting server the potential benefits include: 1) since the licensing, activation, and reporting server are all contained in one “umbrella,” troubleshooting and maintenance is simpler; 2) updates to the reporting server are seamless across all clients; and 3) the aggregated data on the SaaS could be used for broader analytics across clients. The possible detriments of a client hosted reporting server include: 1) clients will need detailed requirements and instructions for setting up their server; 2) there is a fragmented ecosystem of the merchandise user tracking product, which creates the potential for more points of failure and higher troubleshooting costs; 3) updates to the merchandise user tracking product are dependent on the client upgrading their software; and 4) clients may not want to set up and maintain their own server on their internal network for this purpose. Detriments of an SaaS reporting server may include: 1) variable hardware and operating costs that scale with the number of clients; 2) the SaaS requires that clients are provided with a Service Level Agreement (SLA) guaranteeing a certain percentage of uptime; and 3) having all clients connect to the same reporting server presents a challenge to make sure the clients are properly segmented from one another and that one client cannot access the data of another.

Many modifications and other embodiments of the invention will be readily apparent to one skilled in the art having the benefit of the teachings presented in the foregoing descriptions and the associated drawings. Therefore, it is understood and appreciated that the invention is not to be limited to the specific embodiments disclosed herein, and that modifications to the disclosed embodiments and other undisclosed embodiments are intended to be included within the scope of the appended claims.

That which is claimed is:

1. A merchandising display security system comprising:
a merchandising display configured to display an electronic item of merchandise at a display position in a retail store and to detect user interaction with the electronic item of merchandise;
a digital interface box (DIB); and
a media player operably coupled to the DIB,
wherein the DIB and the media player are configured to communicate with the electronic item of merchandise, and
wherein the merchandising display is configured to communicate with the electronic item of merchandise for generating a security alarm when the electronic item of merchandise is moved to an unauthorized location.

2. The merchandising display system according to claim 1, wherein the merchandising display comprises a display stand configured to removably support the electronic item of merchandise.

3. The merchandising display system according to claim 2, wherein the merchandising display comprises cooperating magnets configured to detect when the electronic item of merchandise has been removed from the display stand, and wherein the DIB or media player is configured to record when the electronic item of merchandise has been removed from the display stand.

4. The merchandising display system according to claim 1, further comprising a digital display monitor configured to display a media presentation relating to the electronic item of merchandise to a user.

5. The merchandising display system according to claim 1, wherein the DIB or media player is configured to obtain identifying information from the electronic item of merchandise and to track information relating to a user's interaction with the electronic item of merchandise.
